(19) United States
(12) Patent Application Publication
(10) Pub. No.: US 2008/0158277 A1
(43) Pub. Date: Jul. 3, 2008

(54) Ejection element driving device, ejection element driving method, computer readable medium, and liquid droplet ejecting apparatus

(75) Inventors: Kota Nakayama, Kanagawa (JP); Kohzo Hara, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/810,838

(22) Filed: Jun. 7, 2007

(30) Foreign Application Priority Data
Dec. 28, 2006 (JP) P2006-355490

(51) Int. Cl. B41J 29/38

(52) U.S. Cl. 347/10; 347/14

(57) ABSTRACT

An ejection element driving device includes a signal selection section and a signal selection control section. The signal selection section selects a drive signal to be applied to each ejection element from among drive signals including a liquid droplet ejection signal for ejecting a liquid droplet from the ejection element and a viscosity increase suppression signal for suppressing increase in a viscosity of liquid to be ejected by each ejection element. The signal selection control section refers to a predetermined parameter for any of the ejection elements for which the liquid droplet ejection signal is not selected. The signal selection control section exercises control over whether or not the signal selection section selects the viscosity increase suppression signal for the ejection elements for which the liquid droplet ejection signal is not selected, at each ejection cycle.

### CROSS-REFERENCE TO RELATED APPLICATIONS

This application is based on and claims priority under 35 U.S.C. §119 from Japanese Patent Application No. 2006-355490 filed on Dec. 28, 2006.

### BACKGROUND

1. Technical Field

The invention relates to an ejection element driving device, an election element driving method, a computer readable medium that stores an ejection element driving program, and a liquid droplet ejecting apparatus.

2. Related Art

A piezoelectric element is used as an ejection element for ejecting ink droplets from an inkjet printer. When such an ejection element is continuously left in a non-ejecting state, an increase in the viscosity of ink would occur, which may result in an ejection failures or clogging.

### SUMMARY

According to an aspect of the invention, an ejection element driving device includes a signal selection section and a signal selection control section. The signal selection section selects a drive signal to be applied to each ejection element from among drive signals including a liquid droplet ejection signal for ejecting a liquid droplet from the ejection element and a viscosity increase suppression signal for suppressing increase in a viscosity of liquid to be ejected by each ejection element. The signal selection control section refers to a predetermined parameter for any of the ejection elements for which the liquid droplet ejection signal is not selected. The signal selection control section exercises control over whether or not the signal selection section selects the viscosity increase suppression signal for the ejection elements for which the liquid droplet ejection signal is not selected, at each ejection cycle.

### BRIEF DESCRIPTION OF THE DRAWINGS

Exemplary embodiments of the invention will be described in detailed below with reference to the accompanying drawings, wherein:

FIG. 1 is a functional block diagram of an ejection element driving device according to an exemplary embodiment 1 of the invention;

FIG. 2 is a timing chart of operations from a time when a shift register accepts selection signals to a time when a decoder outputs selection instruction signals;

FIGS. 3A to 3C are tables for explaining control over selection of a viscosity increase suppression signal executed by a signal selection control section;

FIG. 4 is a flow chart of an operation example of the ejection element driving device according to an exemplary embodiment of the invention;

FIG. 5 is a functional block diagram of an ejection element driving device according to an exemplary embodiment 2 of the invention;

FIG. 6 shows an example of a relationship between temperatures and predetermined parameters;

FIG. 7 shows the general configuration of a liquid droplet ejecting apparatus according to the exemplary embodiment 1;

FIG. 8 shows the general configuration of the liquid droplet ejecting apparatus according to the exemplary embodiment 1;

FIG. 9 shows an example of a relationship between temperatures and predetermined parameters; and

FIG. 10 shows a relationship among recording modes, ink types, and predetermined parameters.

### DETAILED DESCRIPTION

Exemplary embodiments of the invention will be described with reference to the accompanying drawings.

### Exemplary Embodiment 1

In this exemplary embodiment, an inkjet recording apparatus for recording an image on a recording medium by ejecting ink droplets will be described as an example of a droplet ejecting apparatus that ejects liquid droplets.

The term “liquid droplet ejecting apparatus” is not limited to an apparatus that ejects ink. This term covers any apparatus that ejects droplets of a liquid, e.g., an apparatus that ejects liquid for improving image quality by controlling the penetration of ink into a recording medium after the ink landing in the recording medium or liquid for absorbing infrared wavelengths but not absorbing visible light; a color filter manufacturing apparatus for manufacturing a color filter by ejecting ink on a film or glass; an apparatus for forming bumps for mounting components by ejecting molten solder onto a substrate; an apparatus for forming a wiring pattern by ejecting a liquid metal; and various film forming apparatus for forming a film by ejecting droplets of liquid.

### General Configuration of Inkjet Recording Apparatus of Exemplary Embodiment 1

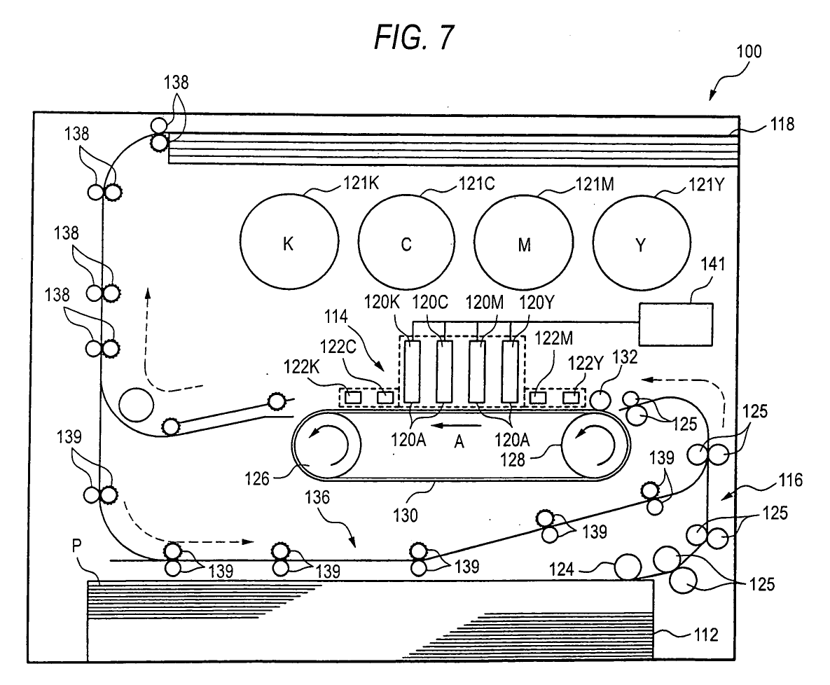

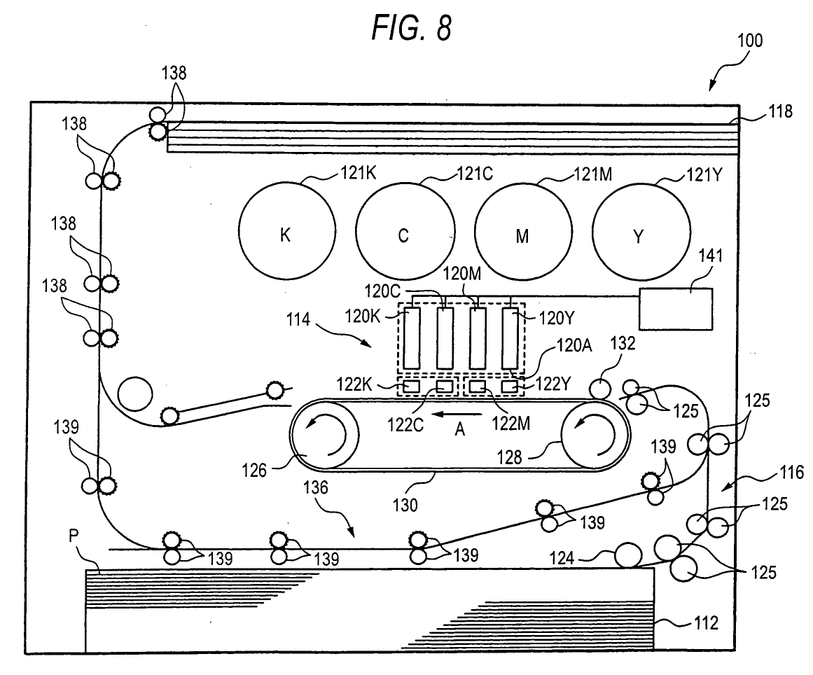

First, the general configuration of an inkjet recording apparatus 100 of this exemplary embodiment will be described. FIGS. 7 and 8 schematically show the general configuration of the inkjet recording apparatus 100 of this exemplary embodiment.

As shown in FIGS. 7 and 8, the inkjet recording apparatus 100 includes a recording medium containing section 112 in which recording media P such as paper are contained, an image recording section 114 that records images on the recording media P, a conveying device 116 that conveys the recording media P from the recording medium containing section 112 to the image recording section 114, and a recording media discharge section 118 that discharges the recording media P having images recorded thereon by the image recording section 114.

The image recording section 114 includes inkjet recording heads 120Y, 120M, 120C, and 120K (the reference numerals will be hereinafter denoted as “120Y to 120K”) that record images on the recording media P by ejecting droplets of ink, which are shown as examples of liquid droplet ejecting heads for ejecting liquid droplets through nozzles.

The inkjet recording heads 120Y to 120K are disposed in an order of the ink colors, i.e., yellow (Y), magenta (M), cyan (C), and black (K), the yellow head being located at the most upstream end when viewed in the direction in which the recording media P are conveyed. Each of the inkjet recording heads 120Y to 120K is equipped with a pressure chamber filled with ink having a corresponding color, a piezoelectric element that changes the volume of the pressure chamber according to a drive signal input from outside, and plural ejection elements which are in communication with the pressure chamber and which have nozzles for ejecting droplets of the ink. The heads are configured to record an image by ejecting the ink droplets having the respective colors from nozzle surfaces 120A on which the plural nozzles are formed.

Each of the inkjet recording heads 120Y to 120K is capable of recording an image over a width that is equal to or greater than the width of an image recording region of the recording media P. The term “width” used here means a length in an intersection direction that intersects the conveying direction of the recording media P. Further, the inkjet recording heads 120Y to 120K are formed by connecting plural units having ink droplet ejecting nozzles provided thereon in the intersection direction, and the heads are therefore long in the intersection direction.

The inkjet recording apparatus 100 is provided with ink tanks 121Y, 121M, 121C, and 121K for storing the ink. The ink is supplied from the ink tanks 121Y, 121M, 121C, and 121K to the inkjet recording heads 120Y to 120K, respectively. Referring to the ink supplied to the inkjet recording heads 120Y to 120K, various types of ink may be used including water based inks, oil based inks, and solvent type inks.

The inkjet recording apparatus 100 further includes maintenance units 122Y, 122M, 122C, and 122K (the reference numerals will be hereinafter denoted as “122Y to 122K”) provided for the maintenance operation of the inkjet recording heads 120Y to 120K. The maintenance units 122Y to 120K are configured so as to be movable between (i) opposite positions (see FIG. 8) where they are opposite to the nozzle surfaces 120A of the respective inkjet recording heads 120Y to 120K and (ii) retracted positions (see FIG. 7) where they are retracted from the nozzle surfaces 120A of the inkjet recording heads 120Y to 120K.

Each of the maintenance units 122Y to 120K includes a capping device that covers the nozzle surface 120A of the corresponding one of the inkjet recording heads 120Y to 120K, a receiving member that receives liquid droplets ejected for an auxiliary purpose (idle ejection) and a cleaning member that cleans the nozzle surface 120A of the corresponding one of inkjet recording heads 120Y to 120K. When the maintenance operation of the inkjet recording heads 120Y to 120K is carried out, the inkjet recording heads 120Y to 120K are lifted to a predetermined height, and then the maintenance units 122Y to 120K are moved to the opposite positions to perform various maintenance operations.

The conveying device 116 includes a feed roll 124 for feeding out a recording medium P contained in the recording medium containing section 112, conveying roll pairs 125 for sandwiching and conveying the recording medium P fed out by the feed roller 124, and an endless conveyor belt 130 for causing a recording surface of the recording medium P conveyed by the conveying roll pair 125 to face the inkjet recording heads 120Y to 120K.

The conveyor belt 130 is wound around a driving roll 126 disposed on the downstream, in the conveying direction, of the recording medium P and a driven roll 128 disposed on the upstream, in the conveying direction, of the recording medium P. The belt 130 is configured to circulate in a predetermined direction (direction A in FIG. 7).

A press roll 132 for pressing the recording medium P against the conveyor belt 130 is provided above the driven roll 128. The press roll 132 moves pursuant to the conveyor belt 130 and also serves as a charging roll. The conveyor belt 130 is charged by the press roll 132, and the recording medium P is electrostatically absorbed by the conveyor belt 130 while being conveyed by the conveyor belt 130.

Conveying of the recording medium P by the conveyor belt 130 as thus described causes a relative movement between the inkjet recording heads 120Y to 120K and the recording medium P, and droplets of ink are ejected onto the recording medium P, which is relatively moving, to form an image on the recording medium P.

Alternatively, a configuration in which the inkjet recording heads 120Y to 120K are moved with the recording medium kept stationary may be employed. Any configuration may be employed as long as there is a relative movement between the recording medium P and the inkjet recording heads 120Y to 120K.

The conveyor belt 130 is not limited to the configuration for holding the recording medium P through electrostatic absorption. Alternatively, such a configuration may be employed, that the recording medium P is held using friction between the belt and the recording medium P or using non-electrostatic means such as absorption or adhesion.

A separating nail for separating the recording medium P from the conveyor belt 130 is disposed on the downstream of the conveyor belt 130 so that the separating nail can move toward and away from the belt 130. After the image is recorded by the inkjet recording heads 120Y to 120K, the recording medium P is separated from the conveyor belt 130 due to the curvature of the conveyor belt 130 and the action of the separating nail. In FIGS. 7 and 8, the separating nail is omitted.

Plural conveyor roll pairs 138 are provided on the downstream of the separating nail. The rolls of the roll pairs 138 on the recording surface side of the recording medium P are star wheels. The conveyor roll pairs 138 convey the recording medium P having the image recorded by the image recording section 114 to the recording medium discharge section 118.

An inverting section 136 that inverts the recording medium P is provided below the conveyor belt 130. After the recording medium P is once conveyed downstream by the conveyor roll pairs 138, the conveyor roll pairs 138 reversely rotate to convey the recording medium P to the inverting section 136.

Plural conveyor roll pairs 139 are provided in the inverting section 136. The rolls of the roll pairs 139 on the recording surface side of the recording medium P are star wheels. The recording medium P conveyed into the inverting section 136 is conveyed to the conveyor belt 130 again.

The inkjet recording apparatus 100 includes an ejection control device 141 that controls operations of the inkjet recording heads 120Y to 120K and a system control device, which is not shown, that controls operations of the inkjet recording apparatus 100 as a whole.

The ejection control device 141 is connected to the inkjet recording heads 120Y to 120K. The ejection control device 141 determines timings when ink droplets are ejected according to image data input from outside, determines which ejection elements of the inkjet recording heads 120Y to 120K are used, and applies a drive signal to the ejection elements. The ejection control device 141 also determines ejection elements to which a viscosity increase suppression signal is to be applied as described later from among ejection elements that eject no ink droplet, and applies the viscosity increase suppression signal to such ejection elements.

An image recording operation of the inkjet recording apparatus 100 will now be described.

First, the recording medium P is fed from the recording medium containing section 112 by the feed roll 124 and conveyed to the conveyor belt 130 by the conveyor roll pairs 125 located on the upstream of the conveyor belt 130.

The recording medium P conveyed to the conveyor belt 130 is absorbed and held on the conveyance surface of the conveyor belt 130 and conveyed to a recording position of the inkjet recording heads 120Y to 120K, and an image is recorded on the recording surface of the recording medium P. After the image recording is completed, the recording medium P is separated from the conveyor belt 130 by the separating nail.

When an image is to be recorded only on one side of the recording medium P, the medium is discharged to the recording media discharge section 118 by the conveyor roll pairs 138 located on the downstream of the conveyor belt 130.

When an image is to be recorded on both sides of the recording medium P, after an image is recorded on one side, the recording medium P is inverted by the inverting section 136 and conveyed to the conveyor belt 130 again. An image is then similarly recorded on the other side of the recording medium P, and the recording medium P having images thus recorded on the both sides thereof is discharged to the recording media discharge section 118.

### Configuration of Ejection Element Driving Device of Exemplary Embodiment 1

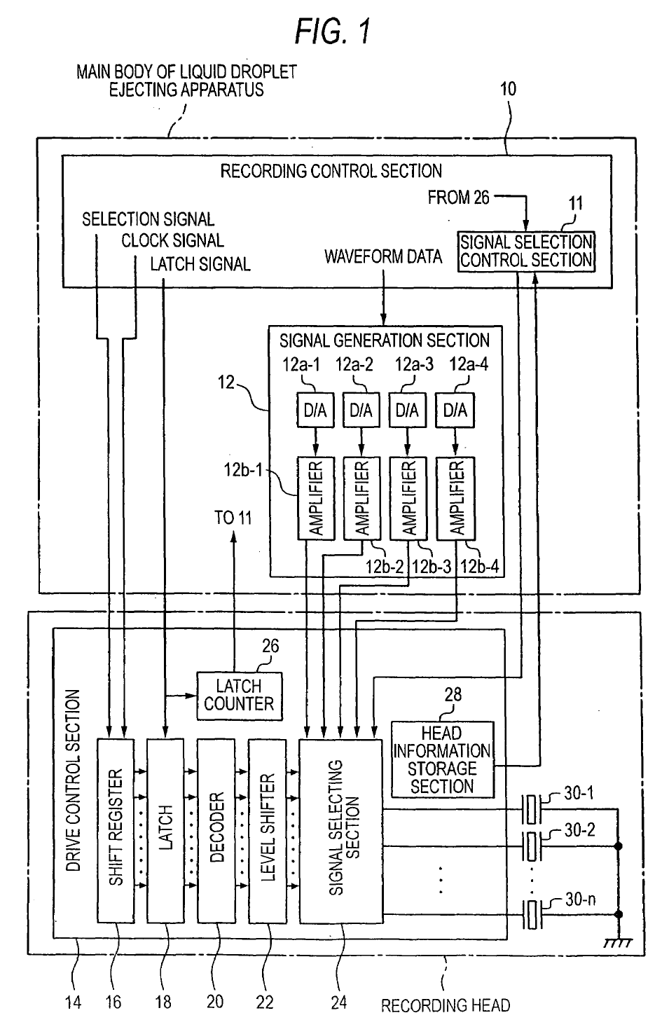

FIG. 1 is a functional block diagram of an ejection element driving device according to this exemplary embodiment of the invention. In FIG. 1, the ejection element driving device includes a recording control section 10 provided as a part of the ejection control device 141 on a main body side of the liquid droplet ejecting apparatus, a signal generation section 12, and a drive control section 14 provided on the liquid droplet ejection head side.

The recording control section 10 includes a central processing unit (CPU) and a program for controlling process operations of the central processing unit, and outputs a clock signal, a selection signal for selecting a signal generated by the signal generation section 12, and a latch signal for controlling the operation of a latch 18. The selection signal is generated based on image data to be recorded. The recording control section 10 also includes a signal selection control section 11 for exercising control over whether or not the signal selection section 24 constituting the drive control section 14 selects a viscosity increase suppression signal at each ejection cycle which will be described later. The viscosity increase suppression signal is selected when none of a large droplet signal, a medium droplet signal, and a small droplet signal, which will be described later, is selected. Further, the recording control section 10 outputs, to the signal generation section 12, waveform data which is digital data for generating the drive signals (the large droplet signal, medium droplet signal, small droplet signal, and viscosity increase suppression signal).

The signal generation section 12 includes digital/analog (D/A) conversion sections 12a-1 to 12a-4 and amplifiers 12b-1 to 12b-4. The D/A conversion sections 12a-1 to 12a-4 convert the waveform data received from the recording control section 10 into analog voltage signals to generate drive signals for ejection elements 30-1 to 30-n. The drive signals include the large droplet signal, medium droplet signal, and small droplet signal for determining sizes (e.g., large, medium, and small) of droplets ejected from the ejection elements 30-1 to 30-n and the viscosity increase suppression signal for suppressing increase in the viscosity of ink. Of those drive signals, the large droplet signal, medium droplet signal, and small droplet signals are liquid droplet ejection signals for ejecting liquid droplets from the ejection elements 30-1 to 30-n, and the viscosity increase suppression signal is a signal for agitating ink in the ejection elements without ejecting liquid droplets. The drive signals are amplified by the amplifiers 12b-1 to 12-4 associated with the respective D/A conversion sections 12a-1 to 12a-4 which have generated the signals, and the signals are then output to the signal selection section 24.

The drive control section 14 includes a shift register 16, the latch 18, a decoder 20, a level shifter 22, the signal selection section 24, a latch counter 26, and a head information storage section 28.

The shift register 16 accepts the selection signals as described above in synchronism with the clock signal, performs parallel conversion of the signals, and outputs the resultant signals to the latch 18. When the number of the ejection elements 30-1 to 30-n in total is 256 (n=256), the selection signals represent 512 bits, that is, 2 bits per each of the ejection elements 30-1 to 30-n. The shift register 16 accepts the selection signal when a latch signal is “H”, and the latch 18 accepts the parallel-converted selection signal from the shift register 16 when the latch signal is “L.”

The latch 18 outputs the selection signals each having 2 bits (256×2 bits) thus acquired to the decoder 20, and the decoder 20 decodes the signals to obtain selection instruction signals for selecting any of the four types of drive signals (the large droplet signal, medium droplet signal, small droplet signal, and viscosity increase suppression signal). The level shifter 22 converts the voltage of the selection instruction signals output from the decoder 20 into a voltage level at which the signal selection section 24 constituted by a switch element and the like can be driven. The decoder 20 generates, according to the 2-bit selection signal received from the latch 18, the selection instruction signal for selecting, for example, the viscosity increase suppression signal when the 2-bit selection signal represents “00;” the small droplet signal when the 2-bit selection signal represents “01;” the medium droplet signal when the 2-bit selection signal represents “10;” and the large droplet signal when the 2-bit selection signal represents “11.”

Based on the selection instruction signal, the signal selection section 24 selects one of the four types of the drive signals input from the signal generation section 12 for each of the ejection elements 30-1 to 30-n, and outputs the resultant signal to each of the ejection elements 30-1 to 30-n. Each of the ejection elements 30-1 to 30-n performs a piezoelectric operation according to the input drive signal to eject an ink droplet or suppress increase in the viscosity of ink.

The latch counter 26 counts cycles of ejection from the election elements 30-1 to 30-n from the period of the H and L levels of the latch signal. Ejection cycles will be described later.

The head information storage section 28 is a device in which information can be recorded appropriately, such as electrical or magnetic storage section. The head information storage section 28 stores information on the liquid droplet ejecting heads 120Y to 120K. In the exemplary embodiment 1, information on the type of the ink used is stored as the information on the liquid droplet ejection heads.

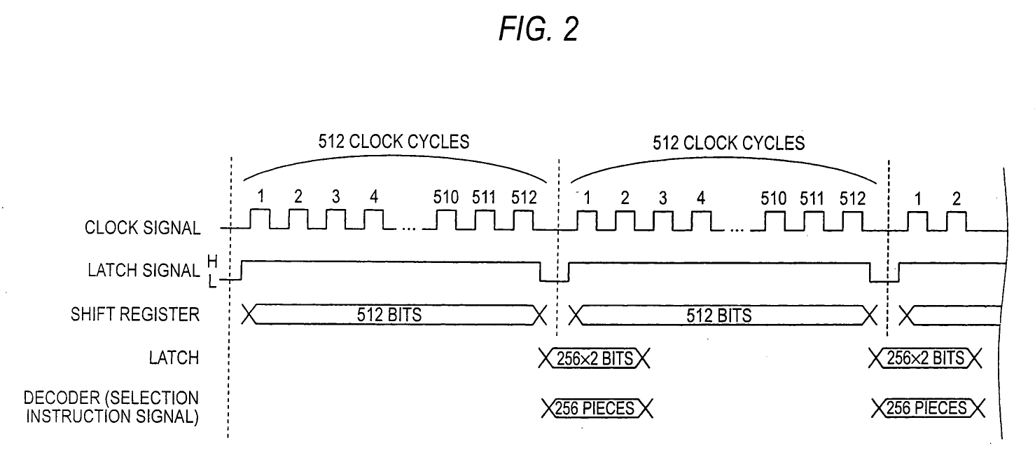

FIG. 2 is a timing chart of operations from a time when the shift register 16 accepts the selection signal to a time when the decoder 20 outputs the selection instruction signals. FIG. 2 shows an example in which the number of the ejection elements 30-1 to 30-n is 256.

Referring to FIG. 2, when the latch signal is “H,” the shift register 16 accepts a 512-bit selection signal from the recording control section 10 based on the clock signal. Next, when the latch signal becomes “L,” the latch 18 accepts the 512-bit (256×2 bits) selection signal from the shift register 16 and performs parallel conversion of the 512-bit selection signal. The selection signal accepted by the latch 18 is decoded by the decoder 20 into selection instruction signals for selecting drive signals for the respective 256 ejection elements 30-1 to 30-n. Thereafter, the signal selection section 24 selects drive signals based on the selection instruction signals, and the ejection elements 30-1 to 30-n are driven accordingly to execute an ejection operation as desired. Since the ejection operation is executed every H/L period of the latch signal, this period is referred to as an “ejection cycle.” Therefore, the latch counter 26 counts ejection cycles by counting H/L periods of the latch signal.

In this exemplary embodiment, the signal selection control section 11 exercises control over whether or not to select the viscosity increase suppression signal, based on the count value of the ejection cycles. Specifically, the signal selection control section 11 generates or stores predetermined parameters to exercise the control over whether or not to select the viscosity increase suppression signal, and causes the signal selection section 24 to select the viscosity increase suppression signal when a predetermined condition is satisfied between the predetermined parameters and the count value.

The predetermined parameters are determined based on, for example, parameter determination information such as ink type information stored in the head information storage section 28. A description will now be made on an example in which the control over whether or not the viscosity increase suppression signal is selected is exercised based on the type of ink. The signal selection control section 11 reads in advance the information on the ink type from the head information storage section 28 to determine a count value for selecting the viscosity increase suppression signal for each ink color as a predetermined parameter. The information stored in the head information storage section 28 may be information identifies the types of the liquids (which are inks, in this example) ejected by the liquid droplet ejecting heads in which the head information storage section 28 is provided. Data format of such information is arbitrarily set. The selection signal control section 11 compares the predetermined parameter determined for each ink color with the count value of the latch counter 26. When the count value of the latch counter 26 matches the predetermined parameter for each ink, the recording control section 10 controls the signal selection section 24 so that the viscosity increase suppression signal is applied to the ejection elements which eject ink having the relevant color among the ejection elements 30-1 to 30-n. When any of the large droplet signal, medium droplet signal, and the small droplet signal, which are liquid droplet ejection signals, is applied to the ejection elements 30-1 to 30-n, the signal selection section 24 does not select the viscosity increase suppression signal. Therefore, the signal selection control section 11 does not exercise the control described above.

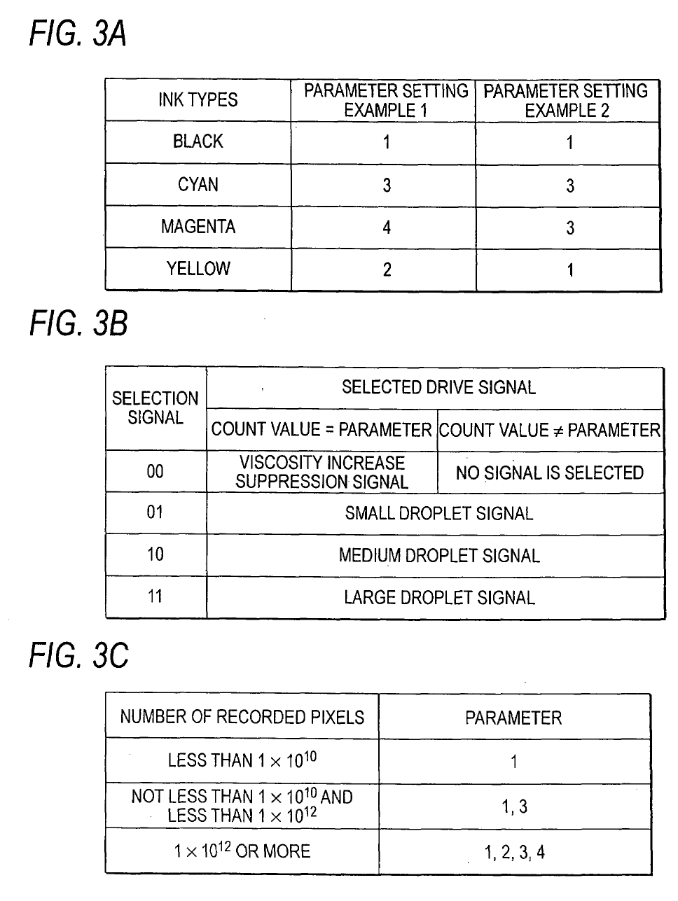

FIGS. 3A and 3B are tables for explaining the control exercised by the signal selection control section 11 to select the viscosity increase suppression signal. FIG. 3A is a table showing an example of a relationship between the four types of inks, i.e., cyan, magenta, yellow, and black inks and the predetermined parameter. FIG. 3B is a table showing how the drive signal is selected according to the selection signal and the predetermined parameter.

For example, a predetermined parameter is set for each ink color as shown in a predetermined-parameter setting example 1 in FIG. 3A. In this example, since the predetermined parameters are integers from 1 to 4, the latch counter 26 counts ejection cycles using count values 1 to 4 which are associated with the numerical range of the predetermined parameters. Specifically, when the latch counter 26 has counted four ejection cycles, the latch counter 26 will continue to count with the next ejection cycle counted as “1.”

Referring to FIG. 3B, when the selection signals are “01,” “10” and “11,” the small droplet signal, the medium droplet signal and the large droplet signal are selected as driving signals, respectively. In the case of the selection signal “00,” the signal selection control section 11 refers to the predetermined parameters shown in FIG. 3A to check whether the predetermined parameter for each ink color matches the count value. When the predetermined parameter for any of the ink colors matches the count value, the signal selection control section 11 controls the signal selection section 24 so that the signal selection section 24 selects and applies the viscosity increase suppression signal to the ejection elements which eject the ink having the relevant color among the ejection elements 30-1 to 30-n. On the other hand, none of the predetermined parameters for the ink colors matches the count value, the signal selection section 24 selects nothing as the drive signal and applies no drive signal to the ejection elements. In this example, when the count value is 1, the viscosity increase suppression signal is applied only to the ejection elements for which the selection signal “00” is generated among the election elements to eject the black ink. When the count value is 2, the viscosity increase suppression signal is applied only to the ejection elements for which the selection signal “00” is generated among the election elements to eject the yellow ink. When the count value is 3, the viscosity increase suppression signal is applied only to the ejection elements for which the selection signal “00” is generated among the election elements to eject the cyan ink. When the count value is 4, the viscosity increase suppression signal is applied only to the ejection elements for which the selection signal “00” is generated among the election elements to eject the magenta ink. As thus described, control is exercised so that the viscosity increase suppression signal is applied once per four cycles even when the selection signals “00” are applied at four or more consecutive ejection cycles.

The predetermined parameter value for each ink color may be appropriately set within the range of the count values. For example, as shown in the predetermined-parameter setting example 2 in FIG. 3A, the viscosity increase suppression signal may be applied to plural ejection elements which eject different types of inks and for which the selection signal “00” is generated, if the same count value is assigned to those ejection elements.

It is not essential that the maximum of the count values agrees with the maximum of the predetermined parameter values set for the respective ink colors. The maximum count value may be greater than the maximum of the predetermined parameter values as long as the set maximum count value results in no ejection failure attributable to increase in ink viscosity. For example, the latch counter 26 may be configured to count ejection cycles using count values 1 to 8 so long as there is no ejection failure attributable to increase in ink viscosity. The frequency of application of the viscosity increase suppression signal is lower, the greater the maximum count value.

The function of comparing the predetermined parameters and the count value may be provided in the drive control section 14. In this case, such a configuration is employed that the drive control section 14 is provided with a storage section for storing the predetermined parameters determined by the signal selection control section 11 and a comparison section that compares the predetermined parameters with a count value. The signal selection section 24 is controlled based on the output of the comparison section.

While the exemplary embodiment shown in FIG. 1 employs such a configuration that the latch counter 26 is provided in the drive control section 14, the latch counter 26 maybe provided in the recording control section 10.

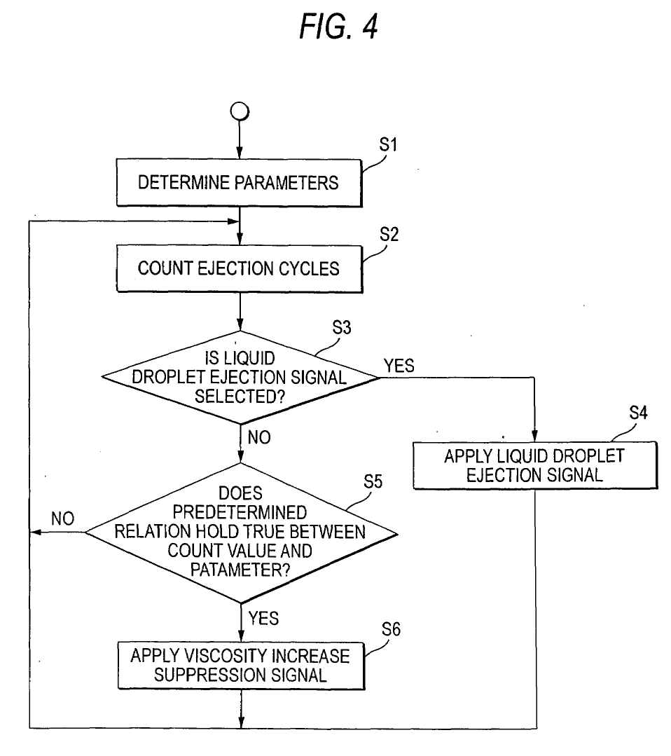

FIG. 4 shows a flow of an operation example of the ejection element driving device according to this exemplary embodiment. Referring to FIG. 4, the signal selection control section 11 determines the predetermined parameters to be used in selecting the drive signals, and the latch counter 26 initializes the ejection cycle (S1). The latch counter 26 then counts one ejection cycle (S2).

The signal selection control section 11 determines as to any of the large droplet signal, the medium droplet signal, and the small droplet signal, which are liquid droplet ejection signals among the drive signals, has been selected for any of the ejection elements 30-1 to 30-n (S3). This determination may be made by the signal selection section 24. When it is determined at step S3 that a liquid droplet ejection signal has been selected for any of the ejection elements 30-1 to 30n, the signal selection section 24 applies the liquid droplet ejection signal to such ejection elements among the ejection elements 30-1 to 30-n (S4) to eject liquid droplets. Thereafter, step S2 and the subsequent steps are repeated, and the process proceeds to control over the next ejection cycle.

With regard to ejection elements among the ejection elements 30-1 to 30n for which it is determined that no liquid droplet ejection signal has been selected, the signal selection control section 11 determines as to whether a predetermined condition is satisfied between the count value and the predetermined parameters of those ejection elements (S5). In this exemplary embodiment, the predetermined condition is that the count value and the predetermined parameter agree with each other.

When it is determined at step S5 that the predetermined condition is satisfied, the signal selection section 24 applies the viscosity increase suppression signal to the ejection elements satisfying the condition among the ejection elements 30-1 to 30-n (S6). Thereafter, the step S2 and the subsequent steps are repeated, and the process proceeds to control over the next ejection cycle.

When it is determined at step S5 that the predetermined condition is not satisfied, none of the drive signals is selected. Then, the step S2 and the subsequent steps are repeated, and the process proceeds to control over the next ejection cycle.

### First Modification of Exemplary Embodiment 1

It has been described above that the signal selection section 24 is configured to select the viscosity increase suppression signal when the predetermined relationship holds true between the count value and the predetermined parameter, e.g., when the count value and the predetermined parameter the agree with each other. However, the invention is not limited thereto. For example, such a configuration may be employed that the viscosity increase suppression signal is selected once when a predetermined count value is reached, e.g., once per two ejection cycles or that the signal is selected periodically. For example, this configuration is implemented by providing the signal selection control section 11 with a select switch which is switched between plural states in a certain sequence. The select switch is switched at each ejection cycle, and the signal selection section 24 selects the viscosity increase suppression signal for ejection elements for which the selection signal “00” is generated when the select switch is in a predetermined state.

### Second Modification of Exemplary Embodiment 1

Such an alternative configuration may be employed that the signal selection control section 11 generates a random number at each ejection cycle in addition to the counting of ejection cycles by the latch counter 26. The signal selection section 24 selects the viscosity increase suppression signal when a predetermined condition holds true between the random number and a predetermined parameter. For example, the configuration involving such a random number is implemented by generating a pseudo random number 0 or 1 at each ejection cycle and setting 0 or 1 as a predetermined parameter in advance. Then, the signal selection section 24 selects the viscosity increase suppression signal for ejection elements for which the selection signal “00” has been generated when the pseudo random number thus generated agrees with the predetermined parameter.

### Third Modification of Exemplary Embodiment 1

Such a further alternative configuration may be employed that the number of recorded pixels is stored in the head information storage section 28, and that the signal selection control section 11 determines a parameter according to the number of recorded pixels, in order to control the frequency of selection of the viscosity increase suppression signal according to deterioration of the ejection elements 30-1 to 30-n with time. For example, the number of pixels recorded as a result of ejection from a liquid droplet ejection head is stored in the head information storage section 28 in the exemplary embodiment 1. The signal selection control section 11 selects a predetermined parameter corresponding to the number of recorded pixels read from the head information storage section 28, based on the relations between the number of recorded pixels and the predetermined parameter which is shown in FIG. 3C instead of FIG. 3A. Then, the signal selection control section 11 compares the selected predetermined parameter with the count value. In this case, since the count value is in the range from 1 to 4, the viscosity increase suppression signal is applied as follows to an ejection element for which the selection signal “00” is consecutively generated. The viscosity increase suppression signal is applied once per four ejection cycles when the number of pixels recorded by the liquid droplet ejection head is smaller than 1×10¹⁰. The viscosity increase suppression signal is applied once per two ejection cycles when the number of recorded pixels is not smaller than 1×10¹⁰ and smaller than 1×10¹². The viscosity increase suppression signal is applied at each ejection cycle when the number of recorded pixels is equal to or greater than 1×10¹².

The relation shown in FIG. 3C is merely an example. This relation may be appropriately set according to the characteristics of the ejection elements and the resolution of the inkjet recording apparatus.

### Fourth Modification of Exemplary Embodiment 1

Control may be exercised so that the viscosity increase suppression signal is not selected for an ejection element which ejects ink in a different color at each ejection cycle (the application of the viscosity increase suppression signal is omitted at an ejection element ejecting ink having a different color at each ejection cycle). The above description has addressed an example in which the viscosity increase suppression signal is applied to an ejection element when the count value agrees with the predetermined parameter. Alternatively, control may be exercised so that the viscosity increase suppression signal is not applied to an ejection element for which the selection signal “00” is generated when the count value agrees with the predetermined value and that the viscosity increase suppression signal is applied to an ejection element for which the selection signal “00” is generated when the count value does not agree with the predetermined parameter value.

In the exemplary embodiment 1 and its modifications, information on the liquid droplet ejection heads is stored in the head information storage section 28 provided in the liquid droplet ejection heads. The signal selection control section 11 acquires this information on the liquid droplet ejection heads from the head information storage section 28. Instead of such a configuration, the information on the heads may be stored in an information storage section (not shown) provided on the main body side of the liquid droplet ejecting apparatus. Such an alternative configuration may be used that the information on the heads is transmitted to the signal selection control section 11 from a computer which transmits image data to the liquid droplet ejecting apparatus.

### Exemplary Embodiment 2

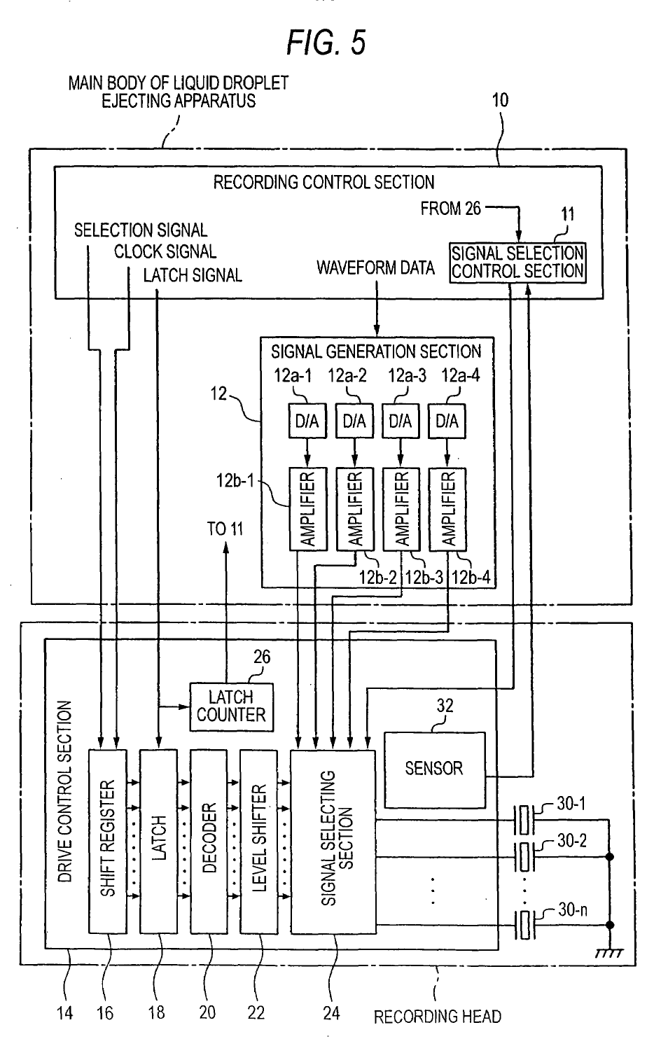

FIG. 5 is a functional block diagram of an ejection element driving device according to an exemplary embodiment 2 of the invention. Elements identical to those in FIG. 1 will be indicated by like reference numerals and will not be described again. Referring to FIG. 5, a sensor 32 that detects states of the liquid droplet ejection heads is provided in the drive control section 14, and the signal selection control section 11 determines parameters as described above based on an output of the sensor 32.

A description will be made on an example in which a temperature sensor is used as the sensor 32. In general, the lower the temperature of the ink is, the viscosity of ink becomes higher to increase the possibility of ejection failures such as clogging. Therefore, the lower the ink temperature is, the predetermined parameters are set so that a viscosity increase suppression signal is more frequently selected. It is determined based on temperatures detected by the temperature sensor, as to whether or not the viscosity increase suppression signal is selected.

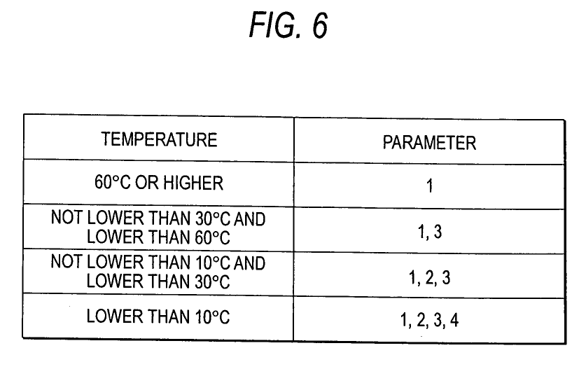

FIG. 6 shows an example of a relation between temperatures detected by the sensor 32 and the predetermined parameters. Referring to FIG. 6, when the latch counter 26 is configured to have cyclical count values of, for example, 1 to 4, the predetermined parameters are set at 1, 2, 3, and 4. All the count values agree with the predetermined parameters at a temperature of 10° C. or lower. That is, the setting is made so that the viscosity increase suppression signal is selected every ejection cycles. Further, the setting is made so that the number of the predetermined parameters is decreased to decrease the frequency of selection of the viscosity increase suppression signal as the temperature increasing. The information transmitted from the temperature sensor to the signal selection control section 11 may be information having contents required for the signal selection control section 11 to set the predetermined parameters. It is not essential that detected temperatures themselves are transmitted. When the relation shown in FIG. 6 is used, any information transmitted from the temperature sensor to the signal selection control section 11 so long as the information can identify one of the four temperature classes shown in FIG. 6 (temperatures lower than 10° C., temperatures not lower than 10° C. and lower than 30° C., temperatures not lower than 30° C. and lower than 60° C., and temperatures not lower than 60° C.).

Although a temperature sensor serving as the sensor 32 in this example shown in FIG. 5 is provided on the liquid droplet ejection head side to detect the temperature of the ejection elements, the invention is not limited thereto. For example, since the temperature of the ejection elements is affected by the temperature of ink supplied to the ejection elements, the temperature sensor may be provided in an ink tank 121 that stores the ink supplied to the ejection elements.

Also, a temperature sensor may be provided at both of the main body of the liquid droplet ejecting apparatus and the liquid droplet ejection heads to control the frequency of selection of the viscosity increase suppression signal using a difference between values detected by the both sensors. The ejection elements 30-1 to 30-n eject ink a greater number of times to increase the temperature of the liquid droplet ejection heads, as the print ration getting higher. Therefore, when such a mode of control is exercised, the frequency of application of the viscosity increase suppression signal can be made lower as the above-described temperature difference getting larger. Information on the print ratio of image data may be acquired from a computer which transmits the image data to a liquid droplet ejecting apparatus employing an ejection element driving device according to this exemplary embodiment of the invention, and the signal selection control section 11 may determine parameters according to the print ratio.

### First Modification of Exemplary Embodiment 2

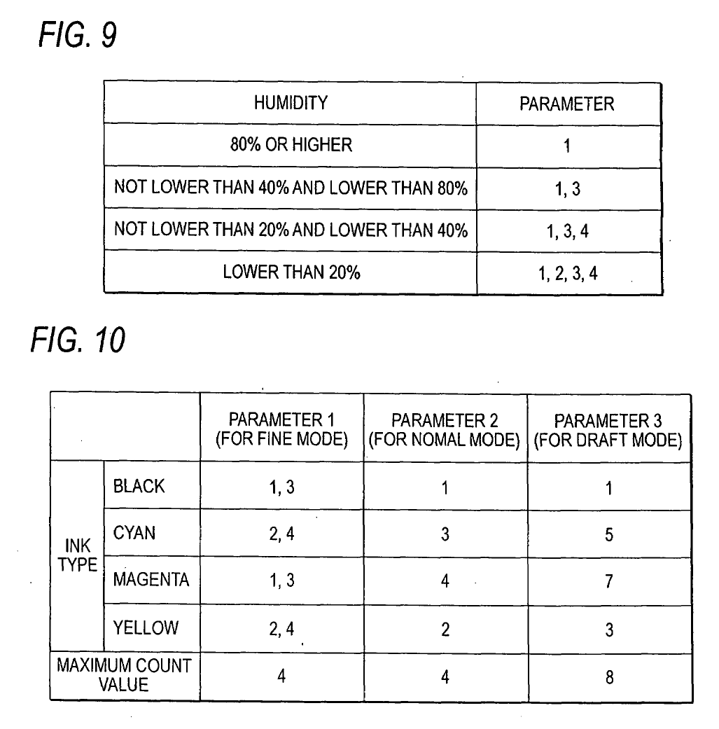

Since the degree of an increase in the viscosity of ink depends also on humidity, a humidity sensor may be used as the sensor 32 in the exemplary embodiment 2. In general, the viscosity of ink increases at a higher rate at lower humidity, which increases the possibility of ejection failures such as clogging. Therefore, the predetermined parameters are set so that the viscosity increase suppression signal is more frequently selected at low humidity, and it is determined as to whether or not a viscosity-increase suppressing waveform is selected, based on the humidity detected by the humidity sensor. For example, the relation between the humidity detected by the humidity sensor and the predetermined parameters is set as shown in the table of FIG. 9. The maximum count value of the latch counter 26 may be a value which is equal to or greater than the maximum value of the values set as the predetermined parameters. In the example shown in FIG. 9, for example, the latch counter 26 is configured to count ejection cycles so as to have count values 1 to 4 cyclically. For humidity lower than 20%, predetermined parameters 1, 2, 3, and 4 are set, and all the count values agree with the predetermined parameters. That is, the viscosity increase suppression signal is selected at all ejection cycles, for ejection elements for which the selection signal “00” is generated. For humidity which is not lower than 20% and lower than 40%, predetermined parameters 1, 3, and 4 are set, and the viscosity increase suppression signal is not selected when the count value is 2. For humidity which is not lower than 40% and lower than 80%, predetermined parameters 1 and 3 are set, and the viscosity increase suppression signal is selected for ejection elements for which the selection signal “00” is generated when the count value is 1 or 3. For humidity of 80% or higher, a predetermined parameter 1 is set, and the viscosity increase suppression signal is selected for ejection elements for which the selection signal “00” is generated when the count value is 1. As thus described, whether or not the viscosity-increase suppressing waveform is selected is determined so that the viscosity increase suppression signal is selected at a high frequency when humidity is low and such that the viscosity increase suppression signal is selected at a lower frequency when humidity is high.

### Exemplary Embodiment 3

Recording modes set in some liquid droplet ejecting apparatus include a fine mode which is required to perform recording with high image quality and a draft mode which is required to perform recording at a high recording speed but which has not so high requirements in terms of image quality. The viscosity increase suppression signal cannot be selected at a low frequency in the fine mode because the low selection frequency of the viscosity increase suppression signal may result in reduction in image quality, whereas the frequency can be set low in the draft mode. Under the circumstance, in a liquid droplet ejecting apparatus utilizing an ejection element driving device according to the exemplary embodiment 1 or 2, information on the recording mode may be acquired from, for example, a computer which transmits image data. Then, the signal selection control section 11 may determine as to whether the viscosity increase suppression signal is selected by selecting a predetermined parameter set in association with the recording mode. Control for varying the selection frequency of the viscosity increase suppression signal according to the recording modes will be described using an example where such control is applied to the exemplary embodiment 1. The description will omit contents common to the exemplary embodiment 1.

FIG. 10 shows examples of predetermined parameters for determining as to whether a viscosity-increase suppressing waveform is selected according to the ink types and the recording modes. Instead of the relation shown in FIG. 3A and used in the exemplary embodiment 1, the predetermined parameters are set based on the relation shown in FIG. 10 in the exemplary embodiment 3. In this exemplary embodiment, the maximum count value is also varied in association with the recording modes. Control for varying the maximum count value in response to the recording mode is implemented by inputting information on a maximum count value from the signal selection control section 11 to the latch counter 26 to cause the latch counter 26 to count according to the input maximum count value. The signal selection control section 11 receives the input of the information on the recording mode (any of the fine mode, the normal mode, and the draft mode) which is transmitted from the computer transmitting the image data or determined based on the contents of a user's input that is supplied using an operation panel provided on the liquid droplet ejecting apparatus. The format of the information on the recording mode may be set appropriately so long as the information on the recording mode identifies any of the recording modes. The signal selection control section 11 compares a predetermined parameter for each ink color associated with the input recording mode with the count value of the latch counter 26. When those values agree, the signal selection section 24 is controlled to apply the viscosity increase suppression signal to ejection elements which eject ink having the relevant color. Specifically, when the recording mode is the fine mode, the latch counter 26 counts ejection cycles to have count values 1 to 4 cyclically. The signal selection section 24 is controlled to apply the viscosity increase suppression signal to ejection elements which eject black and magenta inks and for which the selection signal “00” is generated when the count value is 1 or 3. Also, the signal selection section 24 is controlled to apply the viscosity increase suppression signal to ejection elements which eject cyan and yellow inks and for which the selection signal “00” is generated when the count value is 2 or 4. When the recording mode is the normal mode, the latch counter 26 counts ejection cycles to have count values 1 to 4 cyclically. The signal selection section 24 is controlled to apply the viscosity increase suppression signal to ejection elements which eject black ink and for which the selection signal “00” is generated when the count value is 1; to ejection elements which eject yellow ink and for which the selection signal “00” is generated when the count value is 2; to ejection elements which eject cyan ink and for which the selection signal “00” is generated when the count value is 3; and to ejection elements which eject magenta ink and for which the selection signal “00” is generated when the count value is 4. Such a mode of control allows the viscosity increase suppression signal to be selected at a high frequency in the fine mode which performs recording with high image quality. An increase in the viscosity of ink can therefore be kept relatively small to suppress reduction in image quality. In the draft mode which has not so high requirements in terms of image quality, the frequency of selection of the viscosity increase suppression signal can be kept low.

In the above-described embodiments, driving waveforms to be applied to ejection elements are selected from among a plurality of liquid droplet ejection waveforms for ejecting ink and a coagulation preventing waveform for preventing coagulation of ink, and control is exercised at each ejection cycle with reference to predetermined parameters to determine whether the waveform selection means is to select the coagulation preventing waveform for ejection elements for which the liquid droplet ejecting wave forms are not selected. Such processes may be implemented on a hardware basis by providing a circuit to perform signal selection control, and the processes may alternatively be implemented on a software basis by causing a central processing unit (CPU) to execute a program for performing the processes. When the processes are implemented on a software basis, the program for performing the processes may be provided by storing it in a recording medium such as a CD-ROM, and the program may alternatively be provided using communication means.

The invention is not limited to the above-described embodiments, and various modifications, alterations, and improvements may be made to the same. For example, although the above embodiments have been described on an assumption that liquid droplets are ejected in three sizes, i.e., large, medium, and small sizes, the size of liquid droplets maybe appropriately selected. There may be only one droplet size or four or more droplet sizes. The above embodiments have been described as instances in which liquid droplet ejection heads are capable of recording an image over a width that is equal to or greater than the width of an image recording region of a recording medium P and in which the liquid droplet ejection heads are fixed in the width direction. The invention can be applied to liquid droplet ejecting apparatus in which liquid droplet ejection heads are capable of recording an image over a width that is smaller than the width of an image recording region of a recording medium P and in which the liquid droplets ejection heads record an image by reciprocating in the width direction.

What is claimed is:

1. An ejection element driving device comprising:
a signal selection section that selects a drive signal to be applied to each ejection element from among drive signals including a liquid droplet ejection signal for ejecting a liquid droplet from the ejection element and a viscosity increase suppression signal for suppressing increase in a viscosity of liquid to be ejected by each ejection element; and
a signal selection control section that refers to a predetermined parameter for any of the ejection elements for which the liquid droplet ejection signal is not selected, and that exercises control over whether or not the signal selection section selects the viscosity increase suppression signal for the ejection elements for which the liquid droplet ejection signal is not selected, at each ejection cycle.

2. The device according to claim 1, wherein the signal selection control section counts the ejection cycles and causes the signal selection section to select the viscosity increase suppression signal when a predetermined condition is satisfied between the count value and the predetermined parameter.

3. The device according to claim 1, wherein the signal selection control section generates random number at each ejection cycle and causes the signal selection section to select the viscosity increase suppression signal when a predetermined condition is satisfied between the random number and the predetermined parameter.

4. The device according to claim 1, wherein the signal selection control section acquires parameter determination information for determining the predetermined parameter from a storage section provided on a liquid droplet ejection head on which the plurality of ejection elements are disposed.

5. The device according to claim 4, wherein the parameter determination information for determining the predetermined parameter includes information on a type of the liquid to be ejected.

6. The device according to claim 4, wherein the parameter determination information for determining the predetermined parameter includes at least one of information on temperatures of the ejection elements or information on a temperature of an ejected liquid storing section that supplies the liquid to be ejected to the ejection elements.

7. The device according to claim 4, wherein the parameter determination information for determining the predetermined parameter includes information on humidity of environment in which the ejection elements operate.

8. The device according to claim 1, wherein:
the signal selection control section controls, based on a print ratio of an image to be recorded by the ejection elements, over whether or not the signal selection section selects the viscosity increase suppression signal for the ejection elements for which the liquid droplet ejection signal is not selected, and
the print ration is input from an outside of the ejection element driving device.

9. The device according to claim 1, wherein:
the signal selection control section controls, based on a recording mode in which an image is recorded by the ejection elements, over whether or not the signal selection section selects the viscosity increase suppression signal for the ejection elements for which the liquid droplet ejection signal is not selected, and
the recording mode is input from an out side of the ejection element driving device.

10. A liquid droplet ejecting apparatus comprising:
a liquid droplet ejection head comprising a plurality of ejection elements for ejecting liquid droplets from nozzles, the nozzles disposed on a nozzle surface at predetermined intervals;
the ejection element driving device according to claim 1 that drives the ejection elements based on image data; and
a moving device that moves the nozzle surface and a recording medium relative to each other while keeping the nozzle surface and the recording medium facing each other.

11. A computer readable medium storing a program causing a computer to execute a process for driving ejection elements, the process comprising:
selecting a drive signal to be applied to each ejection element from among drive signals including a liquid droplet ejection signal for ejecting a liquid droplet from the ejection element and a viscosity increase suppression signal for suppressing increase in a viscosity of liquid to be ejected by each ejection element;
referring to a predetermined parameter for any of the ejection elements for which the liquid droplet ejection signal is not selected; and
exercising control over whether or not the viscosity increase suppression signal is selected for the ejection elements for which the liquid droplet ejection signal is not selected, at each ejection cycle.

12. A computer data signal embodied in a carrier wave for enabling a computer to perform a process for driving ejection elements, the process comprising:
selecting a drive signal to be applied to each ejection element from among drive signals including a liquid droplet ejection signal for ejecting a liquid droplet from the ejection element and a viscosity increase suppression signal for suppressing increase in a viscosity of liquid to be ejected by each ejection element;
referring to a predetermined parameter for any of the ejection elements for which the liquid droplet ejection signal is not selected; and
exercising control over whether or not the viscosity increase suppression signal is selected for the ejection elements for which the liquid droplet ejection signal is not selected, at each ejection cycle.

13. An ejection element driving device comprising:
a signal selection section that selects a drive signal to be applied to each ejection element from among drive signals including a liquid droplet ejection signal for ejecting a liquid droplet from the ejection element and a viscosity increase suppression signal for suppressing increase in a viscosity of liquid to be ejected by each ejection element; and
a signal selection control section that refers to a predetermined parameter for any of the ejection elements for which the liquid droplet ejection signal is not selected, and that exercises control over whether or not the signal selection section selects the viscosity increase suppression signal for the ejection elements for which the liquid droplet ejection signal is not selected, at each ejection cycle, wherein:
the signal selection control section counts the ejection cycles, and
the signal selection control section causes, through a certain number of the ejection cycles, the signal selection section repeatedly to select and not to select the viscosity increase suppression signal.
